(19) United States
(12) Patent Application Publication
(10) Pub. No.: US 2017/0135388 A1
(43) Pub. Date: May 18, 2017

(54) COOKED TURKEY WING PRODUCT

(71) Applicant: CARGILL, INCORPORATED, Wayzata, MN (US)

(72) Inventors: Shane M. ACOSTA, Springdale, AR (US); Nicole A. HUFFER, Wichita, KS (US); Oscar ESQUIVEL, Wichita, KS (US); Chad Schafer, Wichita, KS (US)

(73) Assignee: CARGILL, INCORPORTED, Wayzata, MN (US)

(21) Appl. No.: 15/323,341

(22) PCT Filed: Jul. 1, 2015
(86) PCT No.: PCT/US15/38760

§ 371 Date: Dec. 30, 2016

Related U.S. Application Data
(60) Provisional application No. 62/020,552, filed on Jul. 3, 2014.
(60) Provisional application No. 62/026,442, filed on Jul. 18, 2014.

(51) Int. Cl. A23L 13/50; A23B 4/023; A23L 5/10; A23L 13/70

(52) U.S. Cl. CPC A23L 13/55; A23L 13/70; A23B 4/023; A23L 5/10; A23V 2002/00

(57) ABSTRACT

Pre-cooked turkey wing food products are made by a method comprising: providing a plurality of partitioned turkey wing segments; applying a marinade to the partitioned turkey wing segments to form a marinade/partitioned turkey wing segment composition having a ratio of marinade to partitioned turkey wing segments of at least 5:100 by weight; cooking the marinade/partitioned turkey wing segment composition in an environment that retains at least a majority of the marinade in the composition throughout the cooking process, for a time of at least 0.5 hours per pound at an ambient temperature of at least 160 F to provide a cooked marinade/partitioned turkey wing segment composition; cooling the cooked marinade/partitioned turkey wing segment composition; and providing the cooked marinade/partitioned turkey wing segment composition in a packaging format suitable for distribution. In an embodiment, the partitioned turkey wing segments are sub-partitioned midwing portions.

### CROSS-REFERENCE TO RELATED APPLICATIONS

This application claims the benefit of U.S. Provisional Application Ser. No. 62/020,552, filed Jul. 3, 2014, entitled “COOKED TURKEY WING PRODUCT” and of U.S. Provisional Application Ser. No. 62/026,442, filed Jul. 18, 2014, entitled “COOKED TURKEY WING PRODUCT,” which applications are incorporated herein by reference in their entirety.

### FIELD OF THE INVENTION

The present invention relates to a food product. More specifically, the present invention relates to a cooked turkey wing product.

### BACKGROUND OF THE INVENTION

In recent times, turkey meat has become more highly valued as a substitute for red meat. Many portions of the turkey, however, are underutilized because these portions are less highly valued.

U.S. Pat. No. 6,280,311 to Kuck describes a method for cutting and boning a turkey to create a turkey rib cut which includes the scapula bone and its associated muscles (meat). The scapula bone is explained in Kuck to be either of a pair bones lying one in each dorsal lateral part of the thorax, being the principal bone of the corresponding half of the shoulder girdle. The method involves separating the scapula bone and its associated muscles from the turkey carcass. The turkey rib cut may be produced with the cutaneous tissues (turkey skin) attached to the associated muscles. The resulting turkey rib cut is stated to contain a larger percentage of meat and to be easier to produce.

### SUMMARY OF THE INVENTION

Currently, turkey wings are sold mostly in the commodity market and have limited use, mainly because of constraints in delivering a product that is acceptable to the consumer. The present method provides a new product to the marketplace that presents an underutilized food source in an appealing format with convenience for the consumer and assured product quality.

It has been found that the turkey wing is a challenging source of protein to properly prepare, and therefore is an underutilized meat source. It has been found that turkey wing portions must be cooked under conditions that promote tenderness, and it is relatively easy for the ordinary consumer and even the experienced chef to cook turkey wing portions in a manner that presents an undesirable food product. It further has been found that maintenance of control of the cooking process by the meat processor is important in order to assure satisfaction of quality standards, so that the consumer will recognize the new food item as described herein as a reliable, high quality product.

The present invention provides a unique convenience food to the food preparer/consumer that presents turkey wing in attractive portion sizes and assures proper cooking so that the resulting product exhibits superior organoleptic performance. The “partitioned turkey wing segment product is easily eaten by the consumer as a “finger food,” and additionally provides the perceived superior health benefit of poultry as the source of protein.

Specifically, the present method in one embodiment provides pre-cooked turkey wing food products comprising:
providing a plurality of partitioned turkey wing segments selected from the group consisting of drummettes, midwing segments, midwing segments that have been further partitioned into sub-partitioned midwing portions, wingtip segments, and combinations thereof;
applying a marinade to the partitioned turkey wing segments to form a marinade/partitioned turkey wing segment composition having a ratio of marinade to partitioned turkey wing segments of at least 5:100 by weight;
cooking the marinade/partitioned turkey wing segment composition in an environment that retains at least a majority of the marinade in the composition throughout the cooking process, for a time of at least 0.5 hours per pound at an ambient temperature of at least 160° F. to provide a cooked marinade/partitioned turkey wing segment composition;
cooling the cooked marinade/partitioned turkey wing segment composition; and
providing the cooked marinade/partitioned turkey wing segment composition in a packaging format suitable for distribution.

In a particularly preferred embodiment, a method comprises:
providing a plurality of partitioned midwing segments that have been further partitioned into sub-partitioned midwing portions, wherein the sub-partitioned midwing portions are selected from a meat-containing portion comprising a radius bone and that is substantially free of ulna bone, or a meat-containing portion comprising an ulna bone and that is substantially free of radius bone;
applying a marinade to the sub-partitioned midwing portions to form a marinade/partitioned turkey wing segment composition having a ratio of marinade to partitioned turkey wing segment portion of at least 5:100 by weight;
cooking the marinade/partitioned turkey wing segment composition in an environment that retains at least a majority of the marinade in the composition throughout the cooking process, at a temperature of 0.6 hours per pound at an ambient temperature of at least 160° F. to provide a cooked marinade/partitioned turkey wing segment composition;
cooling the cooked marinade/partitioned turkey wing segment composition; and
providing the cooked marinade/partitioned turkey wing segment composition in a packaging format suitable for distribution.

The thus prepared product comprising sub-partitioned midwing portions gives the general appearance of a “rib” product, which has a generally familiar appearance to the consumer while at the same time being a new and unique product. The “rib” product is easily eaten by the consumer as a “finger food,” and additionally provides the perceived superior health benefit of poultry as the source of protein.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is a schematic view of a turkey wing showing certain bones of the wing.

FIG. 2 is a schematic view of a midwing segment prior to partitioning.

FIG. 3 is a photograph of an intact turkey wing.

FIG. 4 is a photograph of the three segments of the turkey wing separated from one another.

FIG. 5 is a photograph of midwing segment prior to sub-partitioning into sub-partitioned midwing portions, with the undesirable skin containing the feather tract present on the segment.

FIG. 6 is a photograph the midwing segment prior to sub-partitioning into sub-partitioned midwing portions, with the undesirable skin containing the feather tract removed.

FIG. 7 is a photograph of the sub-partitioned midwing portions.

FIG. 8 is a photograph of individual components of the midwing segment. From left to right: skin containing feather tract, sub-partitioned midwing portion containing the radius bone, sub-partitioned midwing portion containing the ulna bone, skin containing feather tract.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

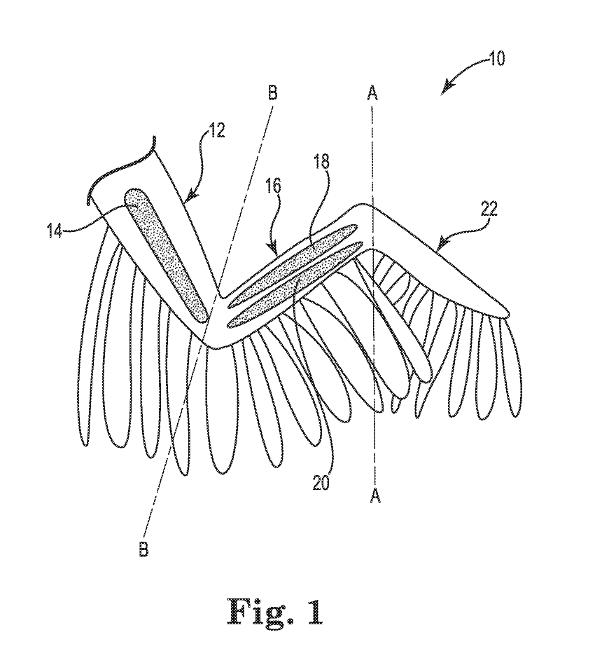

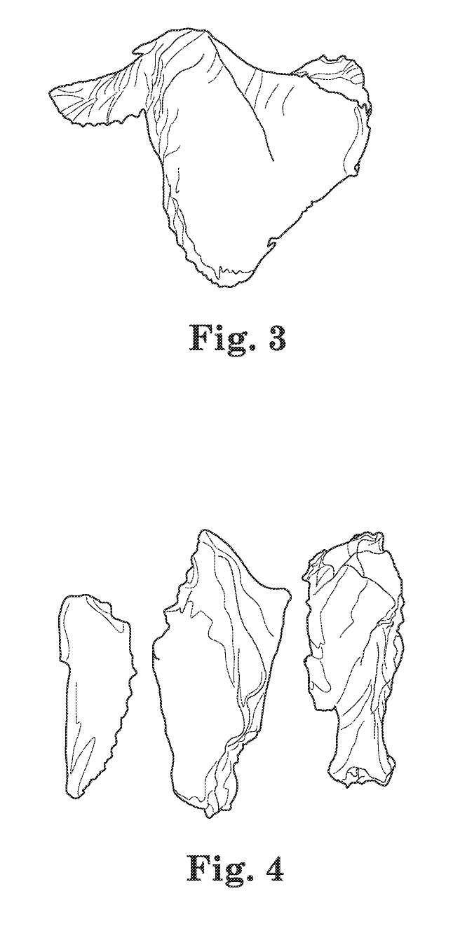

As is illustrated in FIG. 1, a turkey wing 10 consists of three segments: the drummette segment 12 contains the humerus bone 14. The midwing segment 16 contains the radius bone 18 and the ulna bone 20. The wingtip segment 22 (also known as the third segment) contains the phalanges (not shown). As a whole, the wings are too big to sell and geometrically too diverse to commercialize. Partitioning the wings into its segments allows for more uniformity and processing versatility. A photograph of an intact, de-feathered turkey wing is shown as FIG. 3.

An embodiment of the present method utilizes partitioned midwing segments that have been further partitioned into sub-partitioned midwing portions. A partitioned midwing segment is prepared by removing the wingtip segment 22 from the midwing segment 16 by separating generally at line A-A. Likewise, drummette segment 12 is removed from midwing segment 22 by separating generally at line B-B. Preferably, this separation is carried out by cutting with a knife or other suitable cutting tool at the respective joints. A photograph of the three segments of the turkey wing separated from one another is shown as FIG. 4. The components shown are, from left to right, the wingtip segment (containing the carpometacarpus and phalanges bones), the midwing segment (containing the ulna and radius bones), and the drummette segment (containing the humerus bone).

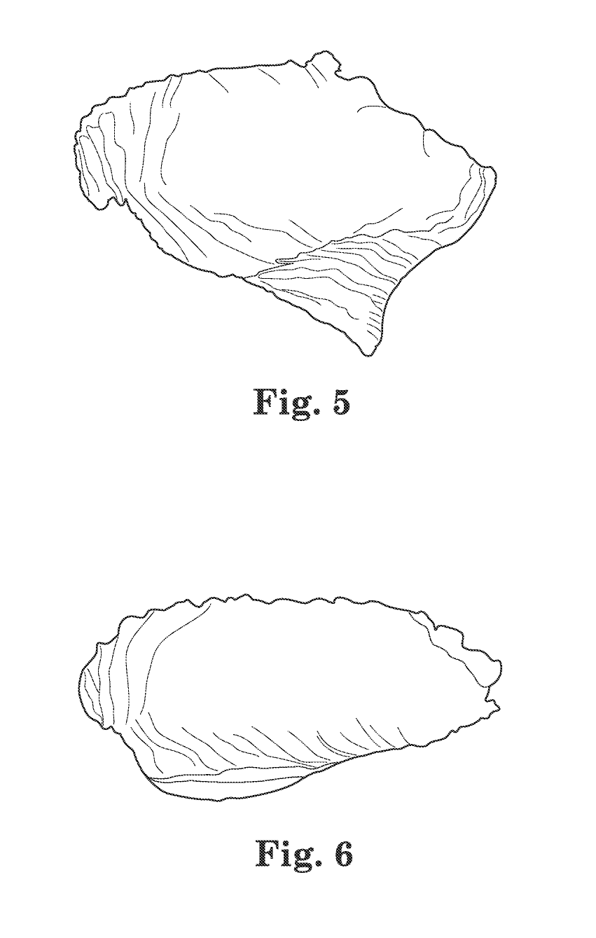

The midwing segment additionally contains undesirable skin and feather track components that are generally organoleptically undesirable to most consumers. FIG. 5 shows a photograph of a midwing segment prior to partitioning with the undesirable skin containing the feather tract present. In a preferred embodiment of the present invention, the undesirable skin containing the feather track is removed from the midwing segment together with the portion of skin that contains the feather track prior to cooking the sub-partitioned midwing. In a preferred embodiment, the feather track and skin portion is removed from the midwing segment prior to further partitioning the midwing segment into sub-partitioned midwing portions. Carrying out this feather track/skin removal step prior to sub-partitioning provides advantages in product handling and in manufacturing processes due to relative ease in manipulating larger wing portions while removing undesired parts. FIG. 6 shows a photograph of a midwing segment prior to partitioning but after removal of the undesirable skin containing the feather tract.

In an embodiment, the three segments of the wing are manually separated from each other. In an embodiment, the three segments of the wing are mechanically separated by automated or semi-automated machine systems. Examples of machines designed for separating turkey wings into their respective segments are described, for example in U.S. Pat. No. 7,341,505 to Gasbarro; U.S. Pat. No. 4,207,653 to Gasbarro; and U.S. Pat. No. 5,496,210 to Davis, which are incorporated herein by reference.

In an embodiment, the segments of the turkey wing are manually separated from each other by cutting through at least one bone. In a preferred embodiment, the segments of the turkey wing are separated by separating the connective tissue between the bones, wherein the blade or other cutting implement does not cut into or otherwise disrupt the bones. Separation of the segments without cutting/disrupting the bone is preferred, because cutting into or disrupting the bone can result in generation of bone shards that are undesirable.

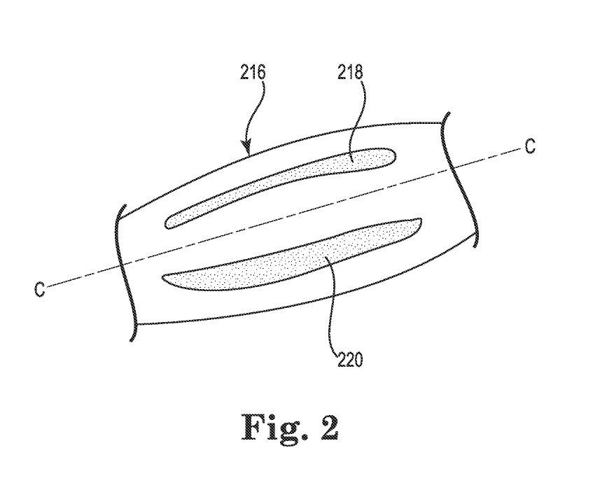

FIG. 2 shows partitioned midwing segment 216 containing the radius bone 218 and the ulna bone 220. In an embodiment, the midwing segment 216 is then longitudinally separated into two sub-partitioned midwing portions by cutting generally at line C-C between the radius bone 218 and the ulna bone 220. This separation provides two sub-partitioned midwing portions that are each bone-in meat portions. In an embodiment, the first meat-containing portion comprises a radius bone and is substantially free of ulna bone. In an embodiment, the second meat-containing portion comprises an ulna bone and is substantially free of radius bone. It will be recognized that under rapid processing conditions, the separation of midwing segment 216 may not always be precise, and that some sub-partitioned midwing portions may contain a portion of the other bone. For purposes of the present invention, “substantially free” means that no more than about 10% of the bone content of the sub-partitioned midwing portion is from either the ulna bone or the radius bone, as the case may be.

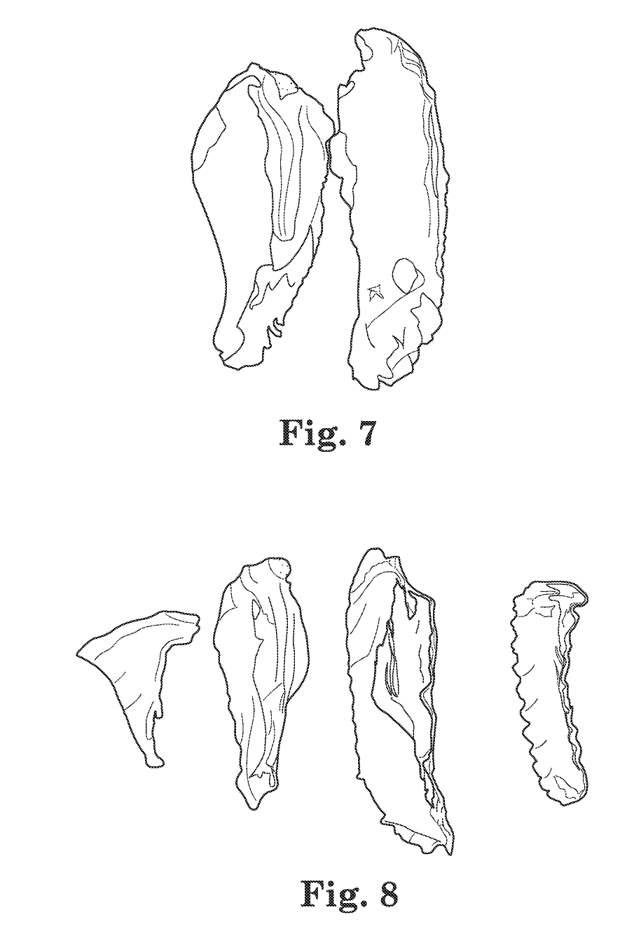

Advantageously, the sub-partitioned midwing portions have the general appearance of “ribs,” which provides appeal to the consumer through visual appeal, portion size and ease of handling when being consumed. FIG. 7 is a photograph of the sub-partitioned midwing portions. FIG. 8 is a photograph of individual components of the midwing segment after sub-partitioning. The photograph shows, from left to right: skin containing feather tract, sub-partitioned midwing portion containing the radius bone, sub-partitioned midwing portion containing the ulna bone, skin containing feather tract.

The thus provided partitioned turkey wing segments under ordinary conditions would be expected to be a low value meat product that would not provide a satisfactory organoleptic experience. However, the present method includes the additional steps described herein provides not only a visually appealing product, but further a reliably flavorful, juicy and texturally pleasing product for easy use by the consumer.

A marinade is then applied to the partitioned turkey wing segments to form a marinade/partitioned turkey wing segment composition having a ratio of marinade to partitioned turkey wing segment of at least 5:100 by weight. In an embodiment, the marinade/partitioned turkey wing segment composition has a ratio of marinade to partitioned turkey wing segment portion of from about 5:100 by weight to about 40:100 by weight. In an embodiment, the marinade/partitioned turkey wing segment composition has a ratio of marinade to partitioned turkey wing segment portion of from about 20:100 by weight to about 35:100 by weight. This embodiment is particularly advantageous when the composition is to be reheated by the ultimate customer under conditions where moisture loss can be expected, such as by frying. In an embodiment, the marinade/partitioned turkey wing segment composition has a ratio of marinade to partitioned turkey wing segment portion of from about 10:100 by weight to about 20:100 by weight. This embodiment is particularly advantageous when the composition is to be reheated by the ultimate customer under conditions where moisture loss is not expected, so that a higher weight content of meat is shipped and provided to the consumer. In a preferred embodiment, the ratio of marinade to partitioned turkey wing segment portion is selected so that after marinade take-up during the application process, the treated partitioned turkey wing segment portion is moist without pooling of liquid marinade.

For purposes of the present invention, weight of the partitioned turkey wing segment portion for calculation of the ratio of marinade to partitioned turkey wing segment portion is the “green weight.” Thus, while the partitioned turkey wing segment portion may be provided with liquid (such as turkey broth) when being mixed with a separately prepared marinade composition, this amount of marinade by weight for purposes of calculating this ratio includes the liquid that may be physically provided with the partitioned turkey wing segment portion.

It will be understood that the marinade/partitioned turkey wing segment composition may comprise in an embodiment an equal distribution of sub-partitioned midwing portions containing the radius bone and sub-partitioned midwing portions containing the ulna bone. In another embodiment, the marinade/partitioned turkey wing segment composition may comprise more of sub-partitioned midwing portions containing the radius bone than of sub-partitioned midwing portions containing the ulna bone. In a preferred embodiment, the marinade/partitioned turkey wing segment composition comprises sub-partitioned midwing portions containing the radius bone, sub-partitioned midwing portions containing the ulna bone and drummette sections of the turkey wing.

In an embodiment, the partitioned turkey wing segment portions are exposed to marinade for a time sufficient for uptake of marinade in an amount of at least about 5:100 marinade to the partitioned turkey wing segment portions by weight. The marinade may be applied to partitioned turkey wing segment portions that are in a frozen state. More preferably, the marinade is applied to partitioned turkey wing segment portions that are in an unfrozen state to provide better penetration of the marinade into the meat. In an embodiment, the turkey wing segment portions are provided in a frozen state and then thawed out during or after application of the marinade. In a preferred embodiment, the turkey wing segment portions have never been frozen and are marinated in the unfrozen state. In an embodiment, the marinade is applied to the partitioned turkey wing segment portions to form a marinade/partitioned turkey wing segment composition that is held at a temperature of from about 32° F. to about 45° F. for a time of at least an hour. In an embodiment, the marinade is applied to the partitioned turkey wing segment portions to form a marinade/partitioned turkey wing segment composition that is held at a temperature of from about 32° F. to about 45° F. for a time of from about one hour to about 48 hours, or from about one hour to about 24 hours.

Preferably, the marinade is applied to the partitioned turkey wing segment portions in a manner that permits rapid partitioned turkey wing segment portion processing at commercially favorable processing rates. In a preferred embodiment, the marinade/sub partitioned turkey wing segment composition is vacuum tumbled at a vacuum of from about 100 Torr to about 20 Torr and for a time of from about 10 to about 40 minutes, or from about 10 to about 30 minutes. Vacuum tumbling advantageously promotes rapid uptake of marinade into the partitioned turkey wing segment portions, and preferably improves the overall distribution of the marinade in the partitioned turkey wing segment portions. Vacuum tumblers are commercially available, such as from Koch Equipment of Kansas City, Mo., or Horizon Bradco of Schenectady, N.Y.

In an embodiment, the marinade is injected into the partitioned turkey wing segment portions at the above-indicated ratios. In an embodiment, partitioned turkey wing segment portions treated by injection of marinade have a meat per portion content of at least about 2 ounces (56.7 grams) in order to have sufficient mass for effective marinade uptake. Injector systems are available from a number of commercial suppliers, such as Metalquimia SA of Girona, Spain and Guenther Maschinenbau GmbH of Dieburg, Germany.

In an embodiment, marinade is applied to all of the partitioned turkey wing segment portions by vacuum tumbling. In another embodiment, marinade is applied to all of the partitioned turkey wing segment portions by injection. In an embodiment, marinade is applied to partitioned turkey wing segment portions having a meat per portion content of at least about 2 ounces by injection, and to partitioned turkey wing segment portions having a meat per portion content of at less than about 2 ounces by vacuum tumbling. In an embodiment, marinade is applied to drummette sections of the turkey wing by injection, and to sub-partitioned midwing portions by vacuum tumbling.

In an embodiment, the marinade-treated partitioned turkey wing segment portions are then treated with a dry rub composition. The dry rub composition provides a further organoleptic benefit by providing topical flavor enhancement and a visually pleasing appearance. Because the marinade-treated partitioned turkey wing segment portions are moist on the surface of the portions, the dry rub naturally adheres to the portions. In an embodiment, the marinade-treated partitioned turkey wing segment portions are tumbled with the dry rub composition to enhance uniformity of the coating of dry rub on the partitioned turkey wing segment portions. In an embodiment, the marinade-treated partitioned turkey wing segment portions are vacuum tumbled with the dry rub composition to enhance uniformity of the coating of dry rub on the partitioned turkey wing segment portions.

In an embodiment, the marinade-treated partitioned turkey wing segment portions are immediately cooked. In another embodiment, the marinade-treated partitioned turkey wing segment portions are allowed to marinate at less than cooking temperature for a time. In an embodiment, the marinade-treated partitioned turkey wing segment portions are held prior to cooking at a temperature of from about 32° F. to about 40° F. for a time of from about 1 hour to about two days preferably from about 1 hour to about 24 hours. In an embodiment, the marinade-treated partitioned turkey wing segment portions are held prior to cooking in a frozen condition, e.g. at a temperature of from about −30° F. to about 32° F. In this embodiment, the manufacturer may obtain efficiencies in production by running the partitioned turkey wing segment portions initial treatment at one time when the product is delivered to the manufacturing site, while effectively holding inventory for later processing at times of consumer demand.

The marinade used in the present invention preferably comprises water and salt. These ingredients in combination provide a valuable juiciness characteristic to the final product, and additionally provide moisture retention during cooking and storage and flavor enhancement. In an embodiment of the present invention, salt is present in an amount of from about 1 to about 10 percent by weight of the total marinade.

In an embodiment, the marinade comprises water, salt, an organic acid, a food grade phosphate, and an antioxidant. In an embodiment, the marinade comprises flavor enhancers such as spices such as black pepper, peppers (including chili pepper and cayenne pepper), garlic, onion, paprika, brown sugar, cumin, oregano and the like. In an embodiment, the marinade may have an overall savory flavor. In an embodiment, the marinade may have an overall sweet flavor. In an embodiment, the marinade is formulated so that the pH of meat after marinating is in the range of 5.8 to 6.2.

Examples of materials that may be included in the marinade of the present invention include compounds that are listed in FSIS directive 7120.1 as “safe and suitable for use in meats and poultry Products,” such as salt, phosphate, sodium lactate, sodium diacetate, citric acid, and sodium bicarbonate. Examples of marinades include those described in U.S. Pat. No. 8,182,858, the disclosure of which is incorporated by reference for this purpose.

The resulting marinade/partitioned turkey wing segment composition is prepared for cooking by placing portions in an environment that retains at least a majority of the marinade in the composition throughout the cooking process. In an embodiment, the cooking environment is a reusable cooking vessel that is covered to retain a majority, if not all, of the marinade so that undue amounts of liquid are not lost to evaporation. In an embodiment, the cooking environment is a reusable-cooking vessel that is sealed to prevent evaporation of marinade liquids. In an embodiment, the cooking environment is a disposable cooking vessel that is covered to retain a majority, if not all, of the marinade so that undue amounts of liquid are not lost to evaporation. In an embodiment, the cooking environment is a disposable cooking vessel that is sealed to prevent evaporation of marinade liquids. In an embodiment, the cooking environment is a heat resistant bag. In an embodiment, the cooking environment is a heat resistant plastic bag. In an embodiment, the cooking environment is a cooking vessel suitable for use as a packaging format for distribution to a consumer.

The marinade/partitioned turkey wing segment composition is cooked in product portion size suitable for handling under food plant operation conditions. In an embodiment, the marinade/partitioned turkey wing segment composition is cooked in product portion size comprising from about 1 pound to about 20 pounds of partitioned turkey wing segment portions in the composition.

In an embodiment, the marinade/partitioned turkey wing segment composition is cooked in product portion size comprising from about 3 pounds to about 10 pounds, or from about 1 pound to about 10 pounds, or from about 3 to about 8 pounds, or from about 5 to about 8 pounds, or from about 3 to about 5 pounds of partitioned turkey wing segment portions in the composition. These relatively smaller portion sizes provide excellent convenience for individual customers or even food service outlets because an appropriate quantity is provided for use or short term refrigeration as needed. For example, the food service provider, such as a restaurant, can allow single packages of the marinade/partitioned turkey wing segment composition to thaw under refrigeration conditions and have the correct amount available for quick heating on demand. Larger portions may lead to waste, because there may not be sufficient demand to use all of the wing portions provided in the container within the recommended refrigerated shelf time of the product. Additionally, smaller portion sizes are preferred because of the flexibility of being able to fit the container in the valuable and limited space available in freezer, refrigerators and/or ovens. Smaller portions also conveniently thaw quicker and cook faster than larger portions due to thermal transfer properties of large blocks of frozen and/or cold meat. In an embodiment, the marinade/partitioned turkey wing segment composition is cooked in product portion size comprising from about 8 pounds to about 20 pounds, or from about 8 pounds to about 15 pounds, from about 10 pounds to about 12 pounds of partitioned turkey wing segment portions in the composition. These relatively larger portion sizes provide excellent convenience for large scale food service provides due to economies of scale.

It has been found that long term cooking of the marinade/partitioned turkey wing segment composition provides substantial benefit to the flavor, tenderness and juiciness of the final product. For this reason, the marinade/partitioned turkey wing segment composition is cooked for a time of at least 0.5 hours per pound at an ambient temperature of from about 160° F. to about 220° F., or from about 160° F. to about 200° F., to provide a cooked marinade/partitioned turkey wing segment composition. In an embodiment, the marinade/partitioned turkey wing segment composition is cooked at an ambient temperature of from about 170° F. to about 190° F. In an embodiment, the marinade/partitioned turkey wing segment composition is cooked at an ambient temperature of from about 180° F. to about 190° F. In an embodiment, the marinade/partitioned turkey wing segment composition is cooked for a time of from about 0.5 hours to about 0.8 hours per pound. In an embodiment, the marinade/partitioned turkey wing segment composition is cooked for a time sufficient for the meat to be held at an internal temperature of from about 175° F. to about 190° F. for a time of from about 0.5 hours to about 0.8 hours per pound. In an embodiment, the marinade/partitioned turkey wing segment composition is cooked for a time sufficient for the meat to be held at an internal temperature of from about 175° F. to about 185° F. for a time of from about 0.5 hours to about 0.8 hours per pound. In an embodiment, the marinade/partitioned turkey wing segment composition is cooked at an ambient temperature of about 185° F. for a time sufficient for the meat to be held at an internal temperature of about 175° F.

The marinade/partitioned turkey wing segment composition can be cooked in any suitable cooking mechanism, which is preferably an oven, convection oven or steam oven. In an embodiment, the marinade/partitioned turkey wing segment composition is cooked under food plant operation conditions processing at least 3,000 pounds of marinade/partitioned turkey wing segment composition per day.

After cooking, the cooked marinade/partitioned turkey wing segment composition is allowed to cool for food storage safety. Cooling can take place before or after placing the cooked marinade/sub-partitioned midwing composition in a packaging format suitable for distribution. In an embodiment, the cooked marinade/partitioned turkey wing segment composition is held for distribution at a temperature of from about 32° F. to about 40° F. In an embodiment, the cooked marinade/partitioned turkey wing segment composition is held for distribution in a frozen condition, e.g. at a temperature of from about −30° F. to about 32° F.

In an embodiment, the packaging format suitable for distribution comprises the heat resistant plastic bag in which the marinade/partitioned turkey wing segment composition was cooked. In an embodiment, the packaging format suitable for distribution is a pouch. In an embodiment, the packaging format suitable for distribution is a sealed package that comprises a tray.

In an embodiment, the packaging format suitable for distribution is an airtight package suitable for storage, transport and presentation to the consumer. The packaging may be of a bulk, shipping, or individual serving type; wherein the container is a formable pouch, injectable pouch, sealable pouch, formable tray, vacuum formable tray or pouch, heat formable tray or pouch, or film covered tray. In an embodiment, the sealed package has headspace over the cooked marinade/partitioned turkey wing segment composition. In an embodiment, the sealed package comprises a tray and has headspace over the cooked marinade/partitioned turkey wing segment composition. In an embodiment, the cooked marinade/partitioned turkey wing segment composition is packaged in a sealed package having an oxygen displaced gas environment, meaning that the amount of oxygen is at least less than present in the common atmosphere. In an embodiment, the amount of oxygen is substantially less than is present in the common atmosphere. Reduction in the exposure of the cooked marinade/sub partitioned turkey wing segment composition to oxygen is advantageous, because this reduces oxidation of the meat. Preferably the gas environment within the meat packaging is purged of oxygen. In an embodiment, the gas environment comprises a gas selected from carbon dioxide, nitrogen, carbon monoxide, nitrous oxide, hydrogen, neon, argon, krypton, xenon and mixtures thereof.

In an embodiment, the sealed package has no headspace over the cooked marinade/partitioned turkey wing segment composition. In an embodiment, the sealed package is vacuum sealed. In an embodiment, the package is sealed after removing air from the package to a pressure of from about 100 to 900 millibars (for purposes of the present invention “partial vacuum”). In an embodiment, the package is sealed after removing air from the package to a pressure of from about 100 to 200 millibars, or from about 125 to about 175 millibars. In an embodiment, the package is sealed after removing air from the package to a pressure of equal to or less than about 100 millibars (for purposes of the present invention “full vacuum”), or from about 5 to 100 millibars, or from about 8 to about 20 millibars, or from about 10 to about 15 millibars. It has been found that packaging under partial or full vacuum is beneficial because the product may be readily frozen with little or no ice crystal formation, and individual pieces of the partitioned turkey wing segment are more readily separated even before complete thawing.

The thus provided packaged, cooked marinade/partitioned turkey wing segment composition may be distributed to retail markets, and food service markets including restaurant, school, hospital and like markets. The customer/food preparer may reheat the cooked marinade/sub partitioned turkey wing segment composition by any suitable method, including by baking, frying, application of steam heat or microwave heating. In an embodiment, the packaged, cooked marinade/partitioned turkey wing segment composition is provided in a container suitable for use as a reheating vessel, such as for heating in a conventional oven or microwave oven.

### EXAMPLES

Representative embodiments of the present invention will now be described with reference to the following examples that illustrate the principles and practice of the present invention.

### Example 1

Pre-cooked turkey wing food products were prepared as follows:
A. Partitioned midwing segments of turkey were further partitioned into sub-partitioned midwing portions.
B. The green weight of the sub-partitioned midwing portions were determined.
C. A marinade was prepared according to the ingredient list set forth in the third column of Table 1 below, and added to the sub-partitioned midwing portions in the amounts as shown in the second column of Table 1 to form a marinade/sub-partitioned midwing composition.

TABLE 1

| | % in Product | % in Marinade |
|---|---|---|
| Wings | 83.333 | |
| Water | 13.417 | 80.540 |
| Organic Acid | 2.500 | 14.990 |
| Phosphate | 0.230 | 1.370 |
| Salt | 0.500 | 2.990 |
| Antioxidant | 0.020 | 0.110 |
| Total | 100.00% | 100.00% |

D. The marinade/sub-partitioned midwing composition was tumbled in a vacuum of from about 100 Torr to about 70 Torr for twenty minutes.
E. A black pepper rub was applied added to the marinade/sub-partitioned midwing composition as shown in Table 2:

TABLE 2

| Rub | % Green |
|---|---|
| Black Pepper | 0.450 |

F. The rub-applied marinade/sub-partitioned midwing composition was vacuum tumbled in a vacuum of from about 100 Torr to about 70 Torr for 5 minutes or until thoroughly coated.
G. The rub-applied marinade/sub-partitioned midwing composition was cooked within eight hours at a temperature of about 180° F. until the meat had an internal temperature of about 180° F.+/−2° F. (82.2° C.+/−1.1° C.)

### Example 2

Pre-cooked turkey wing food products were prepared as follows:
A. Partitioned midwing segments of turkey were further partitioned into sub-partitioned midwing portions.
B. The green weight of the sub-partitioned midwing portions were determined.
C. A marinade was prepared according to the ingredient list set forth in the third column of Table 3 below, and injected into the sub-partitioned midwing portions in the amounts as shown in the second column of Table 3 to form a marinade/sub-partitioned midwing composition.

TABLE 3

| | % in Product | % in Marinade |
|---|---|---|
| Wings | 80.000 | |
| Water | 15.060 | 75.300 |
| Organic Acid | 2.300 | 11.500 |
| Phosphate | 0.280 | 1.400 |
| Salt | 1.000 | 5.000 |
| Antioxidant | 0.020 | 0.100 |
| Turkey Broth | 0.040 | 0.200 |
| Sugar | 1.300 | 6.500 |
| Total | 100.00% | 100.00% |

D. The marinade/sub-partitioned midwing composition was added to a tumbler.
E. A sweet rub was added to the marinade/sub-partitioned midwing composition as shown in Table 4:

TABLE 4

| Rub | % Green |
|---|---|
| Brown Sugar | 3.000 |
| Tomato Powder | 2.000 |
| Molasses | 0.100 |
| Cinnamon | 0.050 |
| Clove | 0.050 |
| Smoke Powder | 0.150 |
| Paprika | 0.500 |

F. The rub-applied marinade/sub-partitioned midwing composition was tumbled without vacuum for 5 minutes or until thoroughly coated.
G. The rub-applied marinade/sub-partitioned midwing composition was cooked within eight hours at a temperature of 190° F. until the meat had an internal temperature about 180° F.+/−2° F. (82.2° C.+/−1.1° C.)

### Example 3

Pre-cooked turkey wing food products were prepared as follows:
A. Partitioned midwing segments of turkey were further partitioned into sub-partitioned midwing portions.
B. The green weight of the sub-partitioned midwing portions were determined.
C. A marinade was prepared according to the ingredient list set forth in the third column of Table 5 below, and added to the sub-partitioned midwing portions in the amounts as shown in the second column of Table 5 to form a marinade/sub-partitioned midwing composition.

TABLE 5

| | % in Product | % in Marinade |
|---|---|---|
| Wings | 79.365 | |
| Water | 17.595 | 85.290 |
| Organic Acid | 2.500 | 12.110 |
| Phosphate | 0.240 | 1.160 |
| Salt | 0.230 | 1.110 |
| Antioxidant | 0.020 | 0.090 |
| Turkey Broth | 0.050 | 0.240 |
| Total | 100.00% | 100.00% |

D. The marinade/sub-partitioned midwing composition was tumbled in a vacuum of from about 100 Torr to about 70 Torr for twenty minutes.
E. A black pepper rub was applied added to the marinade/sub-partitioned midwing composition as shown in Table 6:

TABLE 6

| Rub | % Green |
|---|---|
| Black Pepper | 0.450 |

F. The rub-applied marinade/sub-partitioned midwing composition was vacuum tumbled in a vacuum of from about 100 Torr to about 70 Torr for 5 minutes or until thoroughly coated.
G. The rub-applied marinade/sub-partitioned midwing composition was cooked within eight hours at a temperature of about 180° F. until the meat had an internal temperature of about 180° F.+/−2° F. (82.2° C.+/−1.1° C.)

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values. Alternatively, particularly with respect to biological systems or processes, the term can mean within an order of magnitude, preferably within 5-fold, and more preferably within 2-fold, of a value.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A method of providing pre-cooked turkey wing food products comprising:
providing a plurality of partitioned turkey wing segments selected from the group consisting of drummettes, midwing segments, midwing segments that have been further partitioned into sub-partitioned midwing portions, wingtip segments, and combinations thereof;
applying a marinade to the partitioned turkey wing segments to form a marinade/partitioned turkey wing segment composition having a ratio of marinade to partitioned turkey wing segments of at least 5:100 by weight;
cooking the marinade/partitioned turkey wing segment composition in an environment that retains at least a majority of the marinade in the composition throughout the cooking process, for a time of at least 0.5 hours per pound at an ambient temperature of at least 160° F. to provide a cooked marinade/partitioned turkey wing segment composition;
cooling the cooked marinade/partitioned turkey wing segment composition; and
providing the cooked marinade/partitioned turkey wing segment composition in a packaging format suitable for distribution.

2. The method of claim 1, wherein the partitioned turkey wing segments comprise only drummettes.

3. The method of claim 1, wherein the partitioned turkey wing segments comprise only drummettes and midwing segments.

4. The method of claim 1, wherein the partitioned turkey wing segments comprise only drummettes and midwing segments that have been further partitioned into sub-partitioned midwing portions.

5. The method of claim 1, wherein the partitioned turkey wing segments comprise only wingtip segments.

6. The method of claim 1, wherein the partitioned turkey wing segments comprise only drummettes, midwing segments that have been further partitioned into sub-partitioned midwing portions, and wingtip segments.

7. (canceled)

8. The method of claim 1, wherein the sub-partitioned midwing portions are selected from a meat-containing portion comprising a radius bone and that is substantially free of ulna bone, or a meat-containing portion comprising an ulna bone and that is substantially free of radius bone.

9. A method of providing pre-cooked turkey wing food products comprising:
providing a plurality of partitioned midwing segments that have been further partitioned into sub-partitioned midwing portions, wherein the sub-partitioned midwing portions are selected from a meat-containing portion comprising a radius bone and that is substantially free of ulna bone, or a meat-containing portion comprising an ulna bone and that is substantially free of radius bone;
applying a marinade to the sub-partitioned midwing portions to form a marinade/partitioned turkey wing segment composition having a ratio of marinade to partitioned turkey wing segment portion of at least 5:100 by weight;
cooking the marinade/partitioned turkey wing segment composition in an environment that retains at least a majority of the marinade in the composition throughout the cooking process, for a time of at least 0.5 hours per pound at an ambient temperature of at least 160° F. to provide a cooked marinade/partitioned turkey wing segment composition;
cooling the cooked marinade/partitioned turkey wing segment composition; and
providing the cooked marinade/partitioned turkey wing segment composition in a packaging format suitable for distribution.

10. The method of claim 1, wherein the marinade/partitioned turkey wing segment composition has a ratio of marinade to partitioned turkey wing segment portion of from about 5:100 by weight to about 40:100 by weight.

11. (canceled)

12. The method of claim 1, wherein the marinade is applied to the partitioned turkey wing segment portions and vacuum tumbled at a vacuum of from about 100 Torr to about 20 Torr, and for a time of from about 10 to about 30 minutes.

13. The method of claim 1, wherein the marinade is applied to the partitioned turkey wing segment portions by injection.

14. (canceled)

15. The method of claim 1, wherein the marinade/partitioned turkey wing segment composition has a ratio of marinade to partitioned turkey wing segment portion of from about 10:100 by weight to about 20:100 by weight.

16-19. (canceled)

20. The method of claim 1, wherein the pH of meat after marinating is in the range of 5.8 to 6.2.

21-22. (canceled)

23. The method of claim 1, wherein the packaging format suitable for distribution comprises the heat resistant plastic bag in which the marinade/partitioned turkey wing segment composition was cooked.

24. The method of claim 1, wherein the packaging format suitable for distribution is a pouch.

25. The method of claim 1, wherein the packaging format suitable for distribution is a sealed package that comprises a tray.

26. The method of claim 1, wherein the marinade/partitioned turkey wing segment composition is cooked at an ambient temperature of from about 160° F. to about 200° F.

27. (canceled)

28. The method of claim 1, wherein the marinade/partitioned turkey wing segment composition is cooked for a time of from about 0.5 hours to about 0.8 hours per pound.

29. The method of claim 1, wherein the marinade/partitioned turkey wing segment composition is cooked for a time sufficient for the meat to be held at an internal temperature of from about 175° F. to about 190° F. for a time of from about 0.5 hours to about 0.8 hours per pound.

30. (canceled)

31. The product made by the process of claim 1.
